(19) United States
(12) Patent Application Publication
(10) Pub. No.: US 2014/0067524 A1
(43) Pub. Date: Mar. 6, 2014

(54) OFFER REDIRECTION BASED ON PRIOR ACTIVITY

(71) Applicant: Steel House, Inc., Los Angeles, CA (US)

(72) Inventors: Mark Douglas, Marina Del Rey, CA (US); Takuju Ueda, Rancho Palos Verdes, CA (US)

(73) Assignee: Steel House, Inc., Los Angeles, CA (US)

(21) Appl. No.: 13/947,753

(22) Filed: Jul. 22, 2013

Related U.S. Application Data
(60) Provisional application No. 61/696,687, filed on Sep. 4, 2012.

(51) Int. Cl. G06Q 30/02

(52) U.S. Cl. CPC G06Q 30/0246
USPC 705/14.45

(57) ABSTRACT

There is disclosed a method for redirection based upon a prior offer, the method including accessing a user identification system to uniquely identify a user browsing a website. The method then includes making an offer to the user and determining that the user did not accept the offer. Upon the user's return to a web address associated with the offer, the method redirects the user to the previously presented offer.

### RELATED APPLICATION INFORMATION

This patent claims priority from Provisional Application No. 61/696,687, entitled OFFER REDIRECTION BASED ON PRIOR ACTIVITY, filed Sep. 4, 2012.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

This disclosure relates to offer redirection based on prior activity.

2. Description of the Related Art

Online advertisement continues to grow as Internet users spend increasing time consuming web-based content. Click-throughs and conversions of advertisements are easy to associate with the advertisement. However, brand awareness advertising and subsequent user traffic are more difficult to associate with any particular advertisement.

Current online advertising systems enable advertisers to determine when a user has visited various sites, but do not provide any indication on whether that user has previously received an offer from the site. In addition, the entities responsible for making the offers do not receive any credit for a referral to the site when no direct link exists.

### DESCRIPTION OF THE DRAWINGS

FIG. 1 is a diagram of a computer network.

FIG. 2 is a diagram of a computing device.

FIG. 3 is a diagram of a system for offer redirection based on prior activity.

FIG. 4 is a flowchart of offer server redirection based on prior offers.

FIG. 5 is a flowchart of web server offer redirection based on prior activity.

Throughout this description, elements appearing in figures are assigned three digit reference designators, where the most significant digit is the figure number where the element is introduced and the two least significant digits are specific to the element. An element that is not described in conjunction with a figure may be presumed to be the same as a previously-described element having the same reference designator.

### DETAILED DESCRIPTION

Description of Apparatus

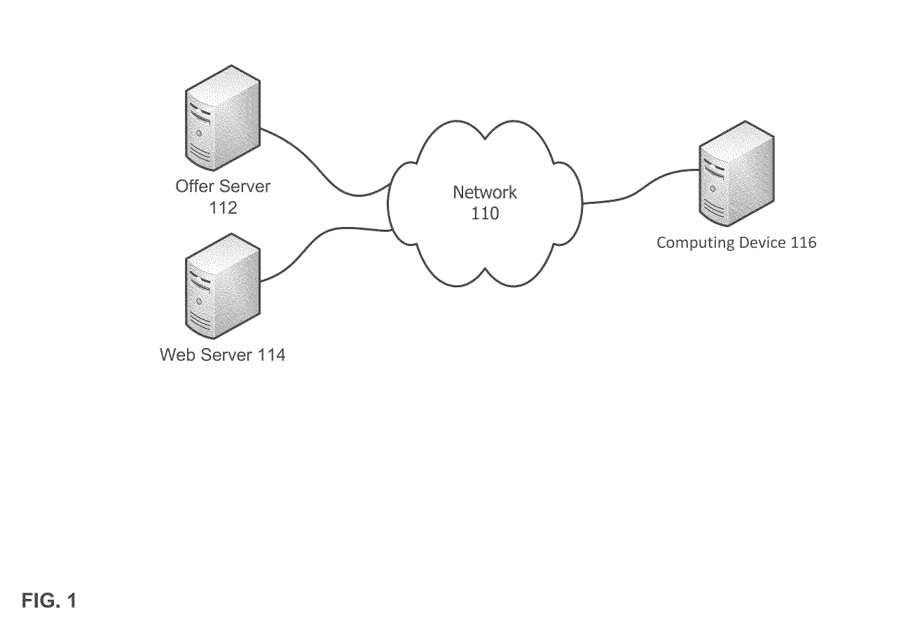

Referring now to FIG. 1, a network 110 is shown. An offer server 112, web server 114 and computing device 116 are attached to the network 110.

The network 110 may take the form of a local network, a wide area network, the Internet or any number of other networks. The network 110 may be implemented locally by physically connected computers or may be distributed over a wide area.

The offer server 112 provides offers to the computing device 116 upon receipt of offer requests. One offer server 112 is shown, but the offer server 112 may include one or more servers capable of providing offers. The offer server 112 may include one or more processors.

The web server 114 serves web pages to the computing device 116. The web server 114 may access or utilize the offer server 112 to provide offers to the computing device 116 when web pages are requested.

The computing device 116 is connected to the network. The computing device 116 is shown as a computer, but may take many forms. The computing device 116 may be a personal computer, lap-top computer, mobile device, a tablet PC, a personal digital assistant, a smartphone, a “dumb” phone, a feature phone, a server computer operating as a part of a distributed or peer-to-peer network or many other forms.

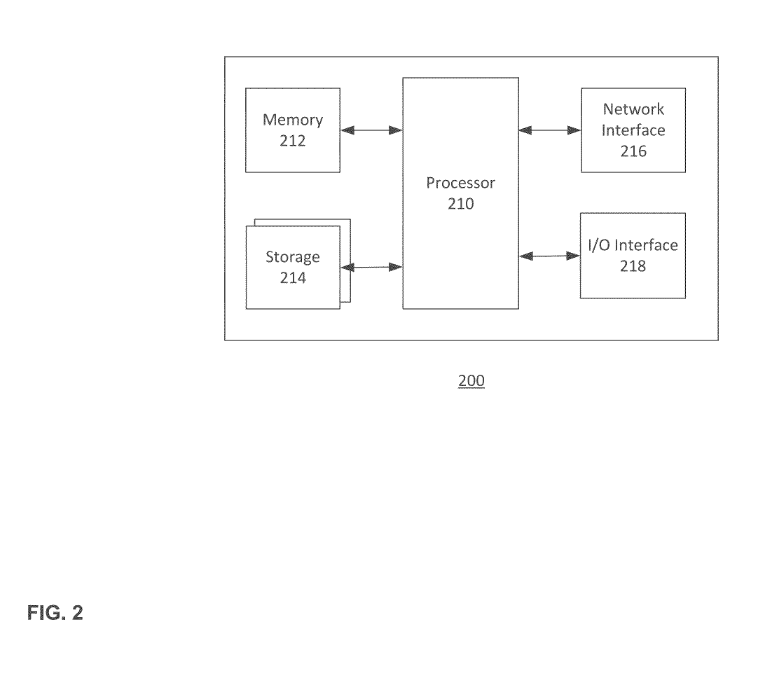

Turning now to FIG. 2, there is shown a computing device 200, which is representative of the server computers, client devices, mobile devices and other computing devices discussed herein. The computing device 200 may include software and/or hardware for providing functionality and features described herein. The computing device 200 may therefore include one or more of logic arrays, memories, analog circuits, digital circuits, software, firmware and processors. The hardware and firmware components of the computing device 200 may include various specialized units, circuits, software and interfaces for providing the functionality and features described herein.

The computing device 200 has a processor 210 coupled to a memory 212, storage 214, a network interface 216 and an I/O interface 218. The processor may be or include one or more microprocessors, field programmable gate arrays (FPGAs), application specific integrated circuits (ASICs), programmable logic devices (PLDs) and programmable logic arrays (PLAs).

The memory 212 may be or include RAM, ROM, DRAM, SRAM and MRAM, and may include firmware, such as static data or fixed instructions, BIOS, system functions, configuration data, and other routines used during the operation of the computing device 200 and processor 210. The memory 212 also provides a storage area for data and instructions associated with applications and data handled by the processor 210.

The storage 214 provides non-volatile, bulk or long term storage of data or instructions in the computing device 200. The storage 214 may take the form of a disk, tape, CD, DVD, or other reasonably high capacity addressable or serial storage medium. Multiple storage devices may be provided or available to the computing device 200. Some of these storage devices may be external to the computing device 200, such as network storage or cloud-based storage. In this patent, the term “storage medium” does not encompass transient media such as signals and waveforms that convey, but do not store information.

The network interface 216 includes an interface to a network such as network 110 (FIG. 1).

The I/O interface 218 interfaces the processor 210 to peripherals (not shown) such as displays, keyboards and USB devices.

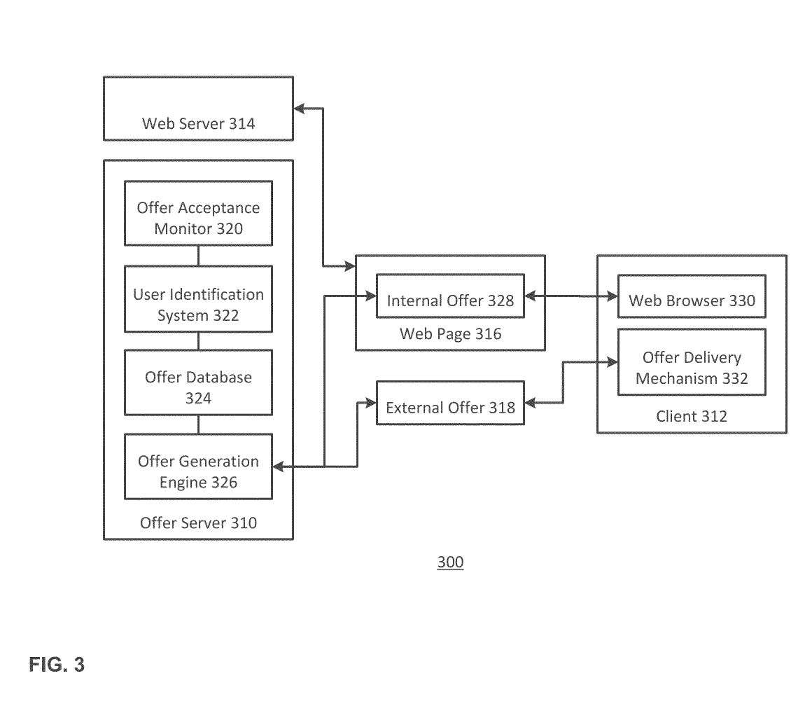

Turning now to FIG. 3, a diagram of a system 300 for offer redirection based on prior activity is shown. The system 300 includes an offer server 310, a client 312, a web server 314 serving a web page 316 an external offer 318. The offer server 310 includes an offer acceptance monitor 320, a user identification system 322, an offer database 324 and an offer generation engine 326. The client 312 includes a web browser 330 and an offer delivery mechanism 332. The web page 316 may incorporate an internal offer 328.

The offer server 310 is a server designed to provide offers. The offer server 310 may provide offers such as advertisements, promotions, discounts, free shipping, free tax, free gifts, survey requests or other offers in response to requests to do so. The offer server incorporates a number of elements. The first is an offer acceptance monitor 320 that determines whether or not an offer made to a user has been accepted.

The offer server 310 also includes a user identification system 322 for identifying a particular user, as explained in further detail below. The offer server 310 also includes an offer database 324 that stores the various offers and the rules associated with those offers. For example, the offer database 324 may include a rule that states that a failure to response to a particular offer may prompt an escalated offer the next time an offer is presented to the user. Alternatively, the offer database 324 may track a user's activities and present offers in response to particular user activities or interactions with the offer server 310 or web server 314.

The offers server 310 also includes an offer generation engine 326 that utilizes the user identification system 322 and the rules in the offer database 324 to generate offers in response to requests to do so. The offer generation engine 326 has access to a database of text offers, display offers or other types of offers that may be provided to a user. These offers may be hosted locally, for example, as a part of the offer database 324, may be hosted on the web server 314 or may be hosted by a service designed to provide high availability to content.

The client 312 is representative of a user operating a device upon which offers may be made. The client 312 may be a personal computer, a mobile phone, a thin client, a television with web access or a similar device. The client 312 includes at least one of a web browser 330 or another offer delivery mechanism 332. The web browser 330 is a typical web browser capable of displaying hypertext markup language and other web-based content.

The offer delivery mechanism 332 may include email messages; SMS texts; dynamic in-email offers displayed when the email is viewed; in-application advertisements, for example, in smartphone applications; audio advertisements via the web, radio or streaming radio; and video advertisements embedded in web-based television, streaming video or purchased or rented video viewed on the client 312. The offer delivery mechanism 332 may be capable of relaying offers to users and providing information to the offer server on the total number of times the offer has been delivered to a particular user.

The web server 314 is a typical web server or web servers capable of serving web content for viewing in a web browser 330. The web server 314 may also serve related content such as streaming audio, video, images and other associated media. The web server 314 may in fact be implemented on a plurality of web servers or a distributed server farm offering high accessibility.

The web server 314 serves web pages, like web page 316 which may include offers like internal offer 328. The web server 314 may or may not be a part of the offer server 310. The web server 314 may be operated or maintained by an offeror, the entity making offers using the offer server 310. The web pages served by the web server 314 may include embedded links, images or other references to offers generated by the offer server 310.

An internal offer 328 is “internal” because it is integrated into a web page 316 viewed by a web browser 330. The external offer 318 is “external” because it is separate and apart from a web page 316. The external offer 318 may take the form of an offer integrated into the offer delivery mechanism 332 described above.

Description of Processes

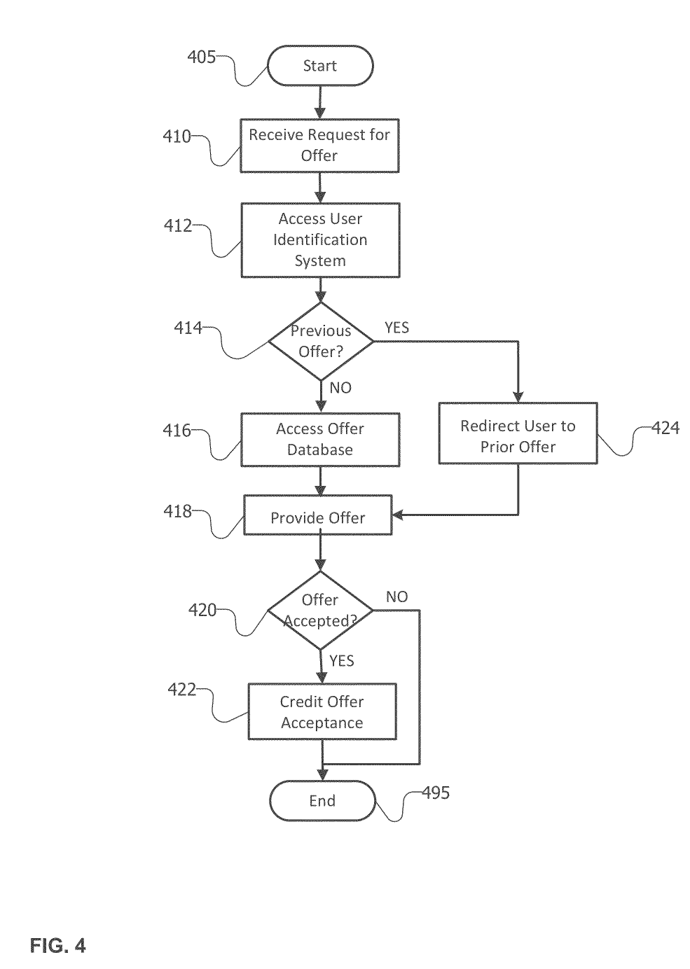

Turning now to FIG. 4, a flowchart of offer server redirection based on prior offers is shown.

First, a request for an offer is received 410. This request may be prompted by a user's visit to a web page serviced by an offer server. As a result of that visit, an embedded link to an offer server, such as offer server 310 (FIG. 3) may be generated. Alternatively, the offer server may be a part of the web server 314 (FIG. 3) serving web pages and offers to the user. The request for an offer asks the offer server 310 to provide an offer to a user.

As a part of that request, identifying information available to the web server 314 regarding the user is also provided. Alternatively, the user is directed to the offer server 310 and the offer server 310 obtains identifying information regarding the user.

The identifying information is used by the offer server to access the user identification system 412 and to, thereby, uniquely identify a user. This identifying information may include a browser cookie, the user's internet protocol address, MAC address, information gathered from other websites that the user has visited, user login data, user profile data associated with a login, internet service provider self-identified data and various other types of identifying information. The identifying information is used by the user identification system to obtain the identity of a user with some degree of certainty.

Once the identity of the user is known, the offer server 310 determines whether or not the user was previously presented with an offer related to the site now being accessed by the user 414. This previous offer information may be stored on the offer server 310 or the client 312. If no offer related to the site being accessed was previously presented to the user, then the offer database is accessed 416. If an offer related to the site being accessed was previously presented to the user, then the user is redirected to the prior offer 424, as explained in further detail below.

The offer database 324 (FIG. 3) is a database of offers that may be presented to users. Using the identity information, the offer database 324 can determine whether a given user has been presented with a particular offer. The offer database 324 may provide various other functionalities in addition to this functionality. The offer database 324 identifies an offer suitable for the user.

Next, the offer will be provided to the user 418. The offer may be a text-based advertisement, a display advertisement, an SMS message, a popup window, or other type of offer made to a user. The offer may be in any form suitable for delivery to a user and subsequent determination regarding the user's acceptance or non-acceptance of that offer.

A determination is then made whether or not the user has accepted the offer 420. This determination may be made, for example, based upon conversion information. Whenever a click through sale is made, the referring site is credited with the click-through. Resulting sales are called conversions and are also credited to the referring site. A lack of response in the form of a click-through or conversion may be considered an indication that the user has not accepted the offer. The user may demonstrate non-acceptance of the offer by navigating to another site, moving to a different area of an application supporting in-application offers, by failing to act within a predetermined time, or by some other manner.

If the offer is accepted, then the system will direct the user to a web address wherein the offer may be redeemed and credit the user acceptance 422 to the offer server. The operator of the offer server 310 may be compensated for user acceptance of offers via click-through revenue and, if the user makes a purchase, conversion revenue. The acceptance also may be noted in the information stored regarding a user as relevant information for future use in selecting other offers for that user.

If the offer is not accepted, the process will await the user's visit to another site or web page serviced by the offer server. At this point, the user may navigate to any number of different web pages. During the course of this browsing, the user may navigate to the same site or to another site associated with the offer. As used herein, the phrase “associated with the offer” means a website featuring the company, product or service previously shown in an offer to a particular user. This navigation may occur, for example, because the user types in the uniform resource locator (URL) of the main web page associated with the product, service or company previously featured in the offer. This navigation may occur through clicking a hyperlink on another web page. The navigation may also occur through a referral or redirection from another site.

Many web pages may be associated with many different offers. For example, a user may visit a plurality of sites, each serviced by the offer server 310. In the course of visiting those sites, the user may receive a plurality of related or unrelated offers. Should the user subsequently visit a URL associated with a product for which he or she has received an offer, it would be considered a visit to a site “associated with the offer.” The user may visit yet another site thereafter offering a service featured in a different, previously-received offer. That website visit would also be “associated with the offer,” even though the offer is only one of many offers received by a user.

These website visits are “associated with the offer” based upon the user who previously received the offer and a plurality of websites that are associated with that offer, for example, in the offer server 310. These websites may be associated by the offeror or by the operator of the websites. Specifically excluded from the definition of “associated with the offer” are sites that are visited as a result of a direct click through from an offer made on a site.

For example, a user may receive an offer of free shipping on new tires. The offer may be made in the form of a text advertisement on a website unrelated to new tires. For example, the advertisement may appear as a part of search results from a search for “automotive parts.” The user does not click through the offer. Subsequently, the user types the web address of the tire manufacturer or a tire retailer into their web browser navigation bar. Rather than visiting the web address input by the user, the user is directed to the web address to which the user would have been directed had the user clicked through the offer.

Many or all of the pages associated with the product or company featured in the offer may incorporate a tracking pixel, system signature identification system or other system of identifying or requesting the identity of a user navigating to that site. Once the user navigates to the site, the system is used to identify the user. This identification may be a part of the normal routine of selecting offers to present to the user. Alternatively, this identification may be a part of the user-tracking associated with the site.

The offer server 310 receives a second request for an offer 410 indicating that a user has requested a web page or other delivery mechanism 332 (FIG. 3) incorporating a request for an offer to be made. The user again may be identified by accessing the user identification system 412.

The system then checks to determine whether or not the user was previously presented with an offer 414. If the user is the same user as before and an offer related to this site was previously presented to the user, then the user may be redirected based on the previous offer 424. Specifically, the user may be redirected to the web address associated with the prior offer in place of the requested web address. Thus, a user is presented with the web page that he or she would have been presented with if the offer were accepted. The web address associated with the prior offer may provide the offer 418 again or may be a landing web address associated with the offer. The offer server 310 may be credited as though the user had clicked on the offer when it was initially presented to them. Alternatively, the user may proceed to the requested web page, but the offer server 310 may be directed to provide the prior offer to the user viewing the website.

Upon redirection to the web address associated with the prior offer, the user may or may not be presented with an opportunity to bypass or decline the offer. The offer may expire or timeout in a predetermined amount of time after presented to the user and the user may then be redirected to the requested URL. Alternatively, the user may be required to affirmatively move on to another page not associated with the prior offer.

A predetermined time period may be set for the validity of a redirection to the prior offer 424. In addition, time-based limitations may be placed upon this association such that the association expires after a period of hours, days, weeks or any other measure of time. Alternatively, the association may expire upon acceptance of the offer by the user or upon the making of a similar offer by a competitor.

For example, a user may be presented with the offer that he or she declines. If the user then visits a web address associated with the entity making the offer within five days thereafter, redirection may occur. If the user visits a web address associated with the entity making the offer after the five days have elapsed, the user will not be redirected. Different time periods may be set by the entity making the offer or the entity operating the offer server. Similarly, a user may be presented with the web address associated with the offer a maximum or minimum number of times before the previous presentation of the offer to the user is no longer relevant. In either case, a new offer will be identified for the user at that time.

The user may then accept the offer or not accept the offer 420. If accepted, the offer server 310 is credited with acceptance 422. Acceptance may mean a click through to the offer or may be a conversion (a sale) based upon the offer. If the user navigates to an associated web page, he or she may be redirected to a web address associated with the previous offer 424 yet again. Alternatively, a user may be redirected to a prior offer a set number of times as set by the entity making the offer, in which case the user may receive a different offer.

The flow chart has both a start 405 and an end 495, but the process is cyclical in nature. Portions of the process may be accomplished in parallel or serially. Multiple instances of the process may be taking place in parallel or serially.

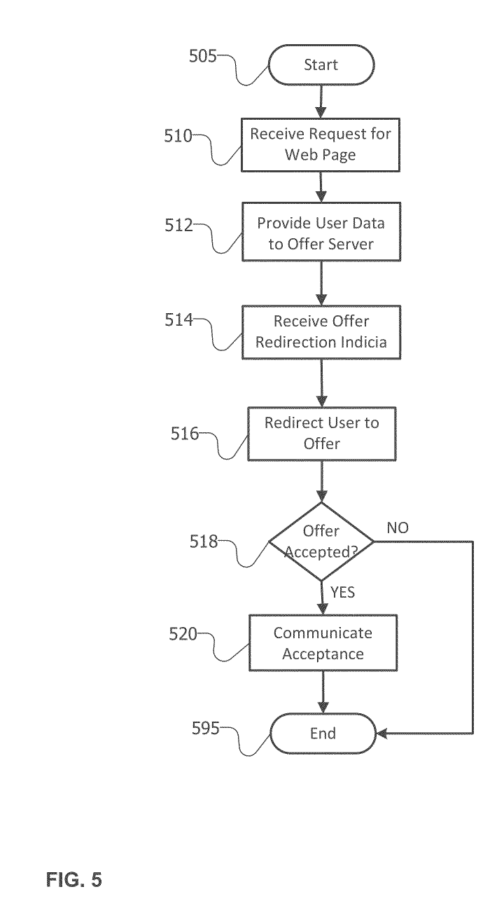

Turning now to FIG. 5, a flowchart of web server offer redirection based on prior activity is shown.

A web server first receives a request for a web page 510. This request may be a click on a link or direct input of a URL into a browser. As a part of this request or as a web page is loaded by a user, the user's data is provided by the web server to the offer server 512. This process may be through the use of a tracking pixel, a system signature or other user identification system.

In response, the offer server 310 may provide offer redirection indicia 514. This offer redirection indicia may indicate that the user was previously presented with an offer related to the site containing the requested web page as described above with reference to FIG. 4. Alternatively, this offer redirection indicia may indicate that the user has previously interacted with the web server in a particular manner. For example, the offer redirection indicia may indicate that a user has returned to a particular web page on the web server many times. This web page, for example, may be a web page associated with a particular product or service. If the user visits the same web page more than a threshold number of times the user may be redirected to an offer, likely one related to the product being viewed, rather than the usual product web page. This redirection may encourage the user to complete the purchase.

Still further alternatively, the offer redirection indicia may indicate that a user has neared purchase of a particular product, for example, moving through the purchase process, but stopping at the calculation of tax or shipping costs. Still further alternatively, the offer redirection indicia may indicate that a user has placed a predetermined dollar value of products into their online shopping cart. At this point, when a user selects to view another web page on the offeror's web site, the offer redirection indicia may indicate that an associated offer, such as free sales tax, free shipping or a free gift may be provided to that customer.

The offer redirection indicia may be stored in or based upon the identifying information obtained from the offer server 310. An offeror may set rules for redirecting to offers such that, for example, a user who has previously placed a product in an online shopping cart, but not completed the purchase once shipping costs were calculated may be redirected to an offer of free shipping upon return to the web page of the offeror or upon return to a product page associated with the product.

In response to the indicia, the web server 310 will be configured to redirect the user to the portion of the site associated with an offer 516. This offer may be an offer previously seen by the user (FIG. 4), an offer intended to encourage a user to complete an online sale that previously was almost completed, an offer in response to a nearly completed purchase of a threshold value of goods or services, or an offer in response to previous activity on the offeror's site or other sites serviced by the offer server 310.

The web server 310 will then determine if the offer is accepted 518. This determination may involve a click through to the offer in situations in which the offer presented is a reiteration of the prior offer. This determination may involve a conversion (sale) based upon the offer. In either situation, if the offer is accepted, the acceptance will be communicated 520 to the offer server 310 (FIG. 3).

If the offer is not accepted, no further communication with the offer server 310 is required. However, the failure to accept the offer may be communicated to the offer server 310 in order to add additional data into the identifying information associated with user.

The flow chart has both a start 505 and an end 595, but the process is cyclical in nature. Portions of the process may be accomplished in parallel or serially. Multiple instances of the process may be taking place in parallel or serially.

### CLOSING COMMENTS

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A method for redirection based on prior offers comprising:
accessing a user identification system to identify a user;
accessing an offer database in order to identify an offer for the user in response to a request for the offer;
providing the offer to the user;
determining that the user did not accept the offer; and
redirecting the user to the offer in response to indicia that the user has navigated to a web address associated with the offer.

2. The method of claim 1 wherein the determining that the user did not accept the offer is based upon the user navigating away from a web address displaying the offer.

3. The method of claim 1 wherein the determining that the user did not accept the offer is based upon a failure of the user to act on the offer within a predetermined time.

4. The method of claim 1 wherein the web address is the home page of the entity making the offer.

5. The method of claim 1 further comprising crediting a provider of the offer with an acceptance of the offer by the user.

6. The method of claim 1 further comprising crediting a provider of the offer with a conversion of the offer by the user upon completion of a sale.

7. An apparatus for offer redirection comprising a storage medium storing software which when executed by a processor will cause the processor to:
access a user identification system to identify a user;
access an offer database in order to identify an offer for the user in response to a request for the offer;
provide the offer to the user;
determine that the user did not accept the offer; and
redirect the user to the offer in response to indicia that the user has navigated to a web address associated with the offer.

8. The apparatus of claim 7 wherein the user navigating away from a web address displaying the offer indicates that the user did not accept the offer.

9. The apparatus of claim 7 wherein the user's failure to act on the offer within a predetermined time indicates that the user did not accept the offer.

10. The apparatus of claim 7 wherein the web address is the home page of the entity making the offer.

11. The apparatus of claim 7 wherein the software will further cause the processor to credit a provider of the offer with an acceptance of the offer by the user.

12. The apparatus of claim 7 wherein software will further cause the processor to credit a provider of the offer with a conversion of the offer by the user upon completion of a sale.

13. The apparatus of claim 7 further comprising:
a processor;
a memory; and
wherein the processor and the memory comprise circuits and software performing the instructions on the storage medium.

14. An apparatus for offer redirection comprising a storage medium storing software which when executed by a processor will cause the processor to:
provide user data to an offer server in response to a request for a web page on a web server from a user; and
redirect the user to a web address on the web server associated with an offer in response to offer redirection indicia indicating that the user was previously presented with the offer and that the user did not accept the offer.

15. The apparatus of claim 14 wherein the software will further cause the processor to communicate acceptance of the offer to the offer server.

16. The apparatus of claim 14 wherein the web page request is initiated by entering a uniform resource locator address into an address bar of a web browser.

17. The apparatus of claim 14 wherein the offer was previously presented to the user in the form of one of a text advertisement, a display advertisement, a pop-up advertisement and an in-line hypertext pop-up advertisement.

18. The apparatus of claim 14 further comprising:
a processor;
a memory; and
wherein the processor and the memory comprise circuits and software performing the instructions on the storage medium.

19. An apparatus for offer redirection comprising a storage medium storing software which when executed by a processor will cause the processor to:
provide user data to an offer server in response to a request for a web page on a web server from a user; and
redirect the user to a web address on the web server associated with an offer in response to offer redirection indicia indicating one of:
that the user has previously initiated an online purchase using the web page and failed to complete a purchase,
that the user has visited the web page on the web server more than a threshold number of times, and
that the user has exceeded a threshold value of goods in an online shopping cart associated with the web page.

20. The apparatus of claim 19 wherein the web page request is initiated by entering a uniform resource locator address into an address bar of a web browser.

21. The apparatus of claim 19 further comprising:
a processor;
a memory; and
wherein the processor and the memory comprise circuits and software performing the instructions on the storage medium.
